(19) United States
(12) Patent Application Publication
(10) Pub. No.: US 2009/0004482 A1
(43) Pub. Date: Jan. 1, 2009

(54) Method of making a stabilized colloidal silica, compositions comprising the same, and coated articles including the same

(75) Inventor: Pramod K. Sharma, Ann Arbor, MI (US)

Correspondence Address: NIXON & VANDERHYE, PC, 901 NORTH GLEBE ROAD, 11TH FLOOR, ARLINGTON, VA, 22203, US

(73) Assignee: Guardian Industries Corp., Auburn Hills, MI (US)

(21) Appl. No.: 11/819,696

(22) Filed: Jun. 28, 2007

(51) Int. Cl. B32B 17/06; B01F 3/12

(52) U.S. Cl. 428/429; 516/34

(57) ABSTRACT

There is provided a method of making a stabilized colloidal silica solution, the method including forming a solution by mixing a colloidal silica, a solvent, and a stabilizing agent, wherein the stabilizing agent is selected from the group consisting of siloxane-based stabilizers, polysorbate-based stabilizers, non-ionic surfactant based stabilizers, and acrylic polymer-based flow-enhancing stabilizers; and agitating the solution. There is also provided methods of using the same in coated articles, and coated articles themselves.

Certain example embodiments of this invention relate to a method of making a stabilized colloidal silica, and the use of such a coating in a coated article where the coating is applied to a glass substrate or the like. The stabilized colloidal silica, which may have an increased shelf life, may be used in various applications, including, for example, UV-blocking coatings in window applications, optical coatings, functional coatings, and so forth.

### BACKGROUND AND SUMMARY OF EXAMPLE EMBODIMENTS OF THE INVENTION

Glass is desirable for numerous properties and applications, including optical clarity and overall visual appearance. For some example applications, certain optical properties (e.g., light transmission, reflection and/or absorption) are desired to be optimized. For example, in certain example instances, reduction of transmission of UV (ultraviolet) radiation through glass may be desirable for storefront windows, IG window units, monolithic window units, display cases, and so forth.

In some circumstances, colloidal silica may play a notable role in various kinds of applications, such as, AR coatings, optical coatings, functional coatings, paint, ceramics, electronics, etc. The particle size of silica in a colloidal solution may be in the nanosize range (<100 nm). The nanosize particles may have high energy and may tend to either agglomerate or grow on aging. This leads to gel formation either instantly or on aging. This is a problem in the art.

Certain example embodiments focus on the stabilization of colloidal silica in solvent and in the formulation for the application of UV blocking coating technology by using siloxane, surface active agent and/or acrylic based polymers. Accordingly, it may be advantageous to prolong the shelf life of a colloidal silica.

Because colloidal silica may relatively unstable in various solvents (such as propanol, methyl ethyl ketones, ethanol, methanol, butanol, etc.), the stabilization of colloidal silica in a solvent may be particularly advantageous.

Thus, there may be a need to prevent or inhibit the formation of gel in a colloidal silica solution.

There may also be a need to affect the particle size distribution of silica particles upon aging.

### BRIEF SUMMARY OF EXAMPLE EMBODIMENTS OF THE INVENTION

It will be appreciated that there may exist a need for an improved UV-blocking coating and method of making the same using a stabilized colloidal silica solution. For example, it may be beneficial to stabilize a colloidal silica in a solvent and use the stabilized colloidal silica in the application of a UV-blocking coating by using siloxanes, surface active agents, and/or acrylic-based polymers.

Certain example embodiments of this invention relate, in part, to the formulation and manufacture of composition(s) containing colloidal silica in a solvent and at least one stabilizer.

These composition(s) may inhibit cloudiness and/or gel formation in solutions containing colloidal silica. These composition(s) may be used in a variety of applications, including, for example, UV-blocking coatings, optical coatings, functional coatings, and so forth. Such UV-blocking coatings may be used in applications such as for storefront windows, IG (insulating glass) window units, monolithic window units, display cases, and so forth.

Certain example embodiments relate to a method of making a stabilized colloidal silica solution, the method comprising: forming a solution by mixing a colloidal silica, a solvent, and a stabilizing agent, wherein the stabilizing agent is selected from the group consisting of siloxane-based stabilizers, polysorbate-based stabilizers, non-ionic surfactant based stabilizers, and acrylic polymer-based flow-enhancing stabilizers; and agitating the solution. In exemplary embodiments, the stabilizing agent comprises less than 10 wt % of the solution or less than 2 wt % of the solution.

In certain example embodiments of this invention, there is provided a method of making a stabilized colloidal silica solution, the method comprising: forming a solution by serially adding the following ingredients: a first solvent; acetone; a stabilizing agent selected from the group consisting of siloxane-based stabilizers, polysorbate-based stabilizers, non-ionic surfactant based stabilizers, and acrylic polymer-based flow-enhancing stabilizers; an intermediate, wherein the intermediate was formed by serially mixing a first silane, a phenone, a triethlyamine, and a second solvent; a second silane; a color stock, wherein the color stock was formed by mixing a third solvent, acetone, a colorant, and a colloidal silica; acetic acid; and water. In exemplary embodiments, the stabilizing agent comprises less than 10 wt % of the solution, less than 5 wt % of the solution, or less than 1 wt % of the solution. In exemplary embodiments, the first silane comprises 3-glycidoxypropyltrimethoxysilane. In exemplary embodiments, the second silane comprises phenyl triethoxysilane, tetraethoxysilane, or both phenyl triethoxysilane and tetraethoxysilane. In exemplary embodiments, the first solvent, second solvent, and/or third solvent comprise an alcohol. In exemplary embodiments, the phenone comprises 2,2,4,4 tetrahydroxybenzophenone.

In certain example embodiments, there is provided a composition comprising a colloidal silica, a solvent, and a stabilizing agent, wherein the stabilizing agent is selected from the group consisting of siloxane-based stabilizers, polysorbate-based stabilizers, non-ionic surfactant based stabilizers, and acrylic polymer-based flow-enhancing stabilizers. In exemplary embodiments, the stabilizing agent comprises less than 10 wt % of the solution or less than 2 wt % of the solution. The composition may be used in making UV blocking coatings.

In certain example embodiments of this invention, there is provided a coated article comprising: a glass substrate; an anti-reflection coating provided on the glass substrate; wherein the anti-reflection coating is formed using a solution that comprises a colloidal silica, a solvent, and a stabilizing agent, wherein the stabilizing agent is selected from the group consisting of siloxane-based stabilizers, polysorbate-based stabilizers, non-ionic surfactant based stabilizers, and acrylic polymer-based flow-enhancing stabilizers. The coated article may be a coated glass substrate used in an IG window unit, a monolithic window unit, a display case, and/or the like.

### BRIEF DESCRIPTION OF THE DRAWINGS

FIG. 1 is a cross-sectional view of a coated article including a UV blocking coating in accordance with an example embodiment of this invention.

FIG. 2 shows the particle size distribution of colloidal silica in a solution made in accordance with an example embodiment of this invention after 21 days.

### DETAILED DESCRIPTION OF EXAMPLE EMBODIMENTS OF THE INVENTION

Referring now more particularly to the accompanying drawings in which like reference numerals indicate like parts throughout the several views.

This invention relates to a composition comprising a stabilized colloidal silica that may be used in an UV-blocking coatings or other suitable coating applications. The UV-blocking coatings may be used on glass substrates in applications such as in IG window units, monolithic window units, display cases, and so forth. For example UV-blocking coatings 3 described herein may be used as the UV-blocking coating(s) in any of U.S. Patent Document Nos. 2007/0128449, 2006/0040108, or 2007/0148601, all of which are hereby incorporated herein by reference.

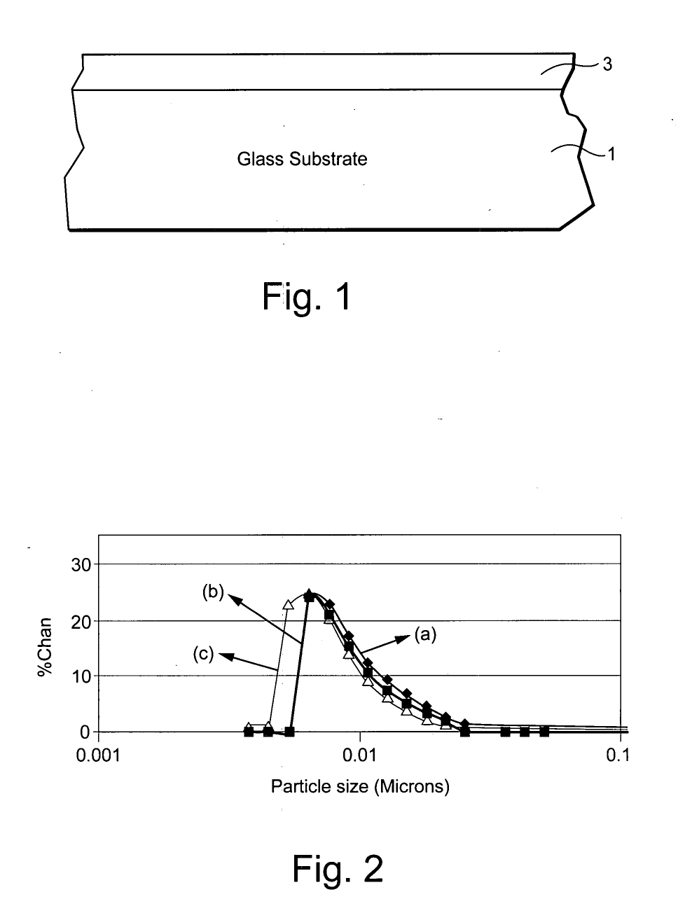

FIG. 1 is a cross sectional view of a coated article according to an example embodiment of this invention. The coated article of FIG. 1 includes a glass substrate 1 and a UV-blocking coating 3 comprising a stabilized colloidal silica. It is also possible to form other layer(s) between substrate 1 and coating 3, and/or over coating 3, in different example embodiments of this invention.

In the FIG. 1 embodiment, the UV-blocking coating 3 includes a suitable UV-blocking composition. The coating may include, for example, porous silica, which may be produced using the sol-gel process involving a stabilized colloidal silica. The composition may contain at least one adjuvant to increase the hardness, durability, transmissivity, and/or other properties of the coating 3. The coating 3 may be any suitable thickness in certain example embodiments of this invention.

Optionally, the coating 3 may also include an overcoat of or including material such as silicon oxide (e.g., SiO₂), or the like, which may be provided over the UV-blocking coating 3 in certain example embodiments of this invention. The overcoat layer may be deposited over coating 3 in any suitable manner. For example, a Si or SiAl target could be sputtered in an oxygen and argon atmosphere to sputter-deposit the silicon oxide inclusive layer. Alternatively, the silicon oxide inclusive layer could be deposited by flame pyrolysis, or any other suitable technique such as spraying, roll coating, printing, via silica precursor sol-gel solution (then drying and curing), coating with a silica dispersion of nano or colloidal particles, vapor phase deposition, and so forth. It is noted that it is possible to form other layer(s) over an overcoat layer in certain example instances. It is noted that layer 3 may be doped with other materials such as titanium, aluminum, nitrogen or the like. Other layer(s) may also be provided on the glass substrate 1.

Set forth below is a description of how a colloidal silica forming a component of the UV-blocking coating 3 may be made according to certain example non-limiting embodiments of this invention.

Exemplary embodiments of this invention provide a method of making a coating solution containing a stabilized colloidal silica for use in coating 3. In certain example embodiments of this invention, the coating solution may be based on a silica sol comprising two different silica precursors, namely (a) a stabilized colloidal silica solution including or consisting essentially of particulate silica in a solvent and (b) a polymeric solution including or consisting essentially of silica chains.

In making the polymeric silica solution for the silica sol, a silane may be mixed with a catalyst, solvent and water. After agitating, the stabilized colloidal silica solution (a) is added to the polymeric silica solution (b), optionally with a solvent.

The coating solution is then deposited on a suitable substrate such as a highly transmissive clear glass substrate 1, directly or indirectly. Then, the coating solution on the glass 1 substrate is cured and/or fired, preferably from about 100 to 750° C., and all subranges therebetween, thereby forming the UV-blocking coating 3 on the glass substrate 1. In certain example embodiments, the coating 3 may have a thickness ranging from 10 to 200 nm, preferably from 50 to 110, and even more preferably from 175 to 185 nm.

In an exemplary embodiment, the sol-gel process used in forming coating 3 may comprise: forming a polymeric component of silica by mixing glycydoxypropyltrimethoxysilane (which is sometimes referred to as “glymo”) with a first solvent, a catalyst, and water; forming a silica sol gel by mixing the polymeric component with a colloidal silica, a stabilizing agent, and a second solvent; casting the mixture by spin coating to form a coating on the glass substrate; and curing and heat treating the coating. Suitable solvents may include, for example, n-propanol, isopropanol, other well-known alcohols (e.g., ethanol), and other well-known organic solvents (e.g., toluene). Suitable catalysts may include, for example, well-known acids, such as hydrochloric acid, sulfuric acid, acetic acid, nitric acid, etc. The colloidal silica may comprise, for example, silica and methyl ethyl ketone. The mixing of the silica sol may occur at or near room temperature for 15 to 45 minutes (and preferably around 30 minutes) or any other period sufficient to mix the two sols either homogeneously or nonhomogeneously. The curing may occur at a temperature between 100 and 150° C. for up to 2 minutes, and the heat treating may occur at a temperature between 600 and 750° C. for up to 5 minutes. Shorter and longer times with higher and lower temperatures are contemplated within exemplary embodiments of the present invention.

Suitable stabilizing agents may include, for example, siloxane-based stabilizers (such as, for example, BYK-345, BYK-346, BYK-347, and BYK-333 available from BYK-Chemie), polysorbate-based stabilizers (such as, for example, Tween-80 available from Sigma-Aldrich), non-ionic surfactant stabilizer (such as, for example, TritonX100 available from Sigma-Aldrich, and Surfynol 502BC, Surfynol 104BC, and Surfynol 104E available from Air Products & Chemicals), and acrylic polymer-based flow-enhancing stabilizers (such as, for example, Lanco Flow WPG available from Noveon Chemicals).

In various embodiments, the stabilizing agent(s) comprise less than 10 wt %; less than 7.5 wt %; less than 5 wt %; less than 2.5%; less than 2 wt %; or less than 1 wt % of a solution comprising solvent, colloidal silica, and stabilizing agent.

In alternative embodiments, one or more additional ingredients, such as organic compounds, metal oxide(s), and/or siloxane(s) may be mixed in during the formation of the sol gel, such as described in a co-pending U.S. patent application Ser. Nos. 11/701,541 (filed Feb. 2, 2007), 11/716,034 (filed Mar. 9, 2007), and 11/797,214 (filed May 1, 2007) each of which is hereby incorporated herein by reference. Alternatively, other components, such as surfactants (including, for example, sodium dodecylsulfate, sodium cholate, sodium deoxycholate (DOC), N-lauroylsarcosine sodium salt, lauryldimethylamine-oxide (LDAO), cetyltrimethylammoniumbromide (CTAB), bis(2-ethylhexyl)sulfosuccinate sodium salt, etc.) may also be present in the coating solution.

The following examples of different embodiments of this invention are provided for purposes of example and understanding only, and are not intended to be limiting unless expressly claimed.

### EXAMPLE #1

In Example #1, 98.8 wt % of colloidal silica in propanol (i.e., commercially available IPA-ST from Nissan Corporation) was mixed with a siloxane-based stabilizer (BYK 345 from BYK-Chemie). The solution was stirred for 5 minutes and kept for aging. The solution contained a gel after 15 minutes, as shown in Table 2

### EXAMPLE #2

In Example #2, 98.8 wt % of colloidal silica in propanol (i.e., commercially available IPA-ST from Nissan Corporation) was mixed with a siloxane-based stabilizer (BYK 346 from BYK-Chemie). The solution was stirred for 5 minutes and kept for aging. The solution contained a gel after 15 minutes, as shown in Table 2

### EXAMPLE #3

In Example #3, 98.8 wt % of colloidal silica in propanol (i.e., commercially available IPA-ST from Nissan Corporation) was mixed with a siloxane-based stabilizer (BYK 347 from BYK-Chemie). The solution was stirred for 5 minutes and kept for aging. The solution contained a gel after 30 minutes, as shown in Table 2.

### EXAMPLE #4

In Example #4, 98.8 wt % of colloidal silica in propanol (i.e., commercially available IPA-ST from Nissan Corporation) was mixed with a siloxane-based stabilizer (BYK 333 from BYK-Chemie). The solution was stirred for 5 minutes and kept for aging. The solution contained a gel after 15 minutes, as shown in Table 2

### EXAMPLE #5

In Example #5, 98.8 wt % of colloidal silica in propanol (i.e., commercially available IPA-ST from Nissan Corporation) was mixed with Tween-80 from Sigma-Aldrich. The solution was stirred for 5 minutes and kept for aging. The solution contained a gel after 2 minutes, as shown in Table 3.

### EXAMPLE #6

In Example #6, 98.8 wt % of colloidal silica in propanol (i.e., commercially available IPA-ST from Nissan Corporation) was mixed with a non-ionic stabilizer in butoxy ethanol system (Surfynol 502BC from Air Products). The solution was stirred for 5 minutes and kept for aging. The solution contained a gel after 6 hours, as shown in Table 3.

### EXAMPLE #7

In Example #7, 98.8 wt % of colloidal silica in propanol (i.e., commercially available IPA-ST from Nissan Corporation) was mixed with a non-ionic surfactant stabilizer (TritonX100 from Sigma-Alrdich). The solution was stirred for 5 minutes and kept for aging. The solution contained a gel after 5 days, as shown in Table 3.

### EXAMPLE #8

In Example #8, 98.8 wt % of colloidal silica in propanol (i.e., commercially available IPA-ST from Nissan Corporation) was mixed with a non-ionic stabilizer in butoxy ethanol system (Surfynol 104BC from Air Products). The solution was stirred for 5 minutes and kept for aging. The solution contained a gel after 5 days, as shown in Table 3.

### EXAMPLE #9

In Example #9, 98.8 wt % of colloidal silica in propanol (i.e., commercially available IPA-ST from Nissan Corporation) was mixed with a non-ionic stabilizer in ethylene glycol system (Surfynol 104E from Air Products). The solution was stirred for 5 minutes and kept for aging. The solution contained a gel after 21 days, as shown in Table 3.

### EXAMPLE #10

In Example #10, 98.8 wt % of colloidal silica in propanol (i.e., commercially available IPA-ST from Nissan Corporation) was mixed with an acrylic polymer system (Lanco Flow WPG from Noveen). The solution was stirred for 5 minutes and kept for aging. The solution contained a gel after 21 days, as shown in Table 3.

TABLE 2
Gelling time of colloidal silica in the presence
of siloxane-based stabilizers

| | | Gelling Time | |
|---|---|---|---|
| Example No. | Stabilizer | (min) | Nature of Gel |
| 1 | BYK-345 | 15 | Thick White |
| 2 | BYK-346 | 15 | Thick White |
| 3 | BYK-347 | 30 | Thick White |
| 4 | BYK-333 | 2 | Thick White |

TABLE 3
Gelling time of colloidal silica in the presence of surfactant- and
polymer-based stabilizers

| Example No. | Stabilizer | Gelling Time | Nature of Gel |
|---|---|---|---|
| 5 | Tween-80 | 2 minutes | Thick White |
| 6 | Surfynol 502BC | 6 hours | White Cloud, Free |
| | | | Flowing Liquid |
| 7 | TritonX-100 | 5 days | White Cloud, Free |
| | | | Flowing Liquid |
| 8 | Surfynol 502BC | 5 days | White Cloud, Free |
| | | | Flowing Liquid |
| 9 | Surfynol 502BC | 21 days | No Cloud, Free |
| | | | Flowing Liquid |
| 10 | Lanco Flow WPG | 21 days | No Cloud, Free |
| | | | Flowing Liquid |

### FORMULATIONS

### Example #11-13

Formulations were made with various ingredients as shown in Table 4 using three separate stabilizers: BYK-345 (Example #1); Surfynol 104E (Example #9); and Lanco Flow WPG (Example #10). All the ingredients were added in the order listed then stirred for about 6 hours.

In the following examples, “color stock” is a solution made by mixing the following ingredients for 30 minutes: 1.5 g of n-propanol, 0.75 g of acetone, 0.0084 g of colorant Savinyl Blue GLS Powder (from Clariant), 0.0063 of colorant Savinyl Pink 6 BLS Powder (from Clariant), and 23.1 g of IPA-ST (from Nissan).

In the following examples, “intermediate” is a solution made by the following procedure: 21.14 wt % of 3-glycidoxypropyltrimethoxysilane (from United Chemical Technology) was heated to a temperature of 175° F. During heating when temperature reached to 140° F., 5.50 wt % 2,2,4,4, tetrahydroxybenzophenone (from Norquay Technology, NY) was added. Once liquid reaches to 175° F. make, wait until the 2,2,4,4 tetrahydroxybenzophenone dissolves completely. 0.026 wt % of triethylamine (from ChemCentral) was added, and the solution was mixed for another 2 hours. The solution was cooled to room temperature and diluted by 73.32 wt % n-propanol (Dow Chemical). The solution was stirred for 30 minutes.

TABLE 4
Formulations containing BYK-345, Surfynol 104E,
and Lanco Flow WPG

| | Example No. 11 | Example No. 12 | Example |
|---|---|---|---|
| Ingredient | (g) | (g) | No. 13 (g) |
| n-Propanol | 31.91 | 31.91 | 31.91 |
| n-Butanol | 12.82 | 12.82 | 12.82 |
| Acetone | 19.42 | 19.42 | 19.42 |
| BYK-345 | 0.15 | 0 | 0 |
| Surfynol 104E | 0 | 0.15 | 0 |
| Lanco Flow WPG | 0 | 0 | 0.15 |
| Intermediate | 51.06 | 51.06 | 51.06 |
| Phenyl | 0.61 | 0.61 | 0.61 |
| triethoxysilane | | | |
| Methyl | 0.55 | 0.55 | 0.55 |
| triethoxysilane | | | |
| Tetraethoxysilane | 1.20 | 1.20 | 1.20 |
| Color Stock | 25.38 | 25.38 | 25.38 |
| Acetic Acid | 0.49 | 0.49 | 0.49 |
| Water | 6.40 | 6.40 | 6.40 |

### EXAMPLE #11

In Example #11, BYK-345 was used as a stabilizer in the formulation using other ingredients shown in Table 4. This formulation was kept for 21 days. The particle size analyzer (using MicroTrac UPA instruments from MicroTrac, Inc.) was used to observe any particle growth in the solution over time. FIG. 2 shows the particle size distribution in the solution after 21 days as series (a). Example #11 has a relatively wide particle size distribution from ˜8 nm to ˜38 nm.

### EXAMPLE #12

Example #12 is similar to Example #11, except Surfynol 104E was used in the formulation instead of BYK-345. Other ingredients were used as shown in Table 4. This formulation was kept for 21 days. The particle size analyzer (using MicroTrac UPA instruments) was used to observe any particle growth in the solution over time. FIG. 2 shows the particle size distribution in the solution after 21 days as series (b). Example #12 has a relatively narrow size distribution from ˜6.5 nm to ˜26 nm.

### EXAMPLE #13

Example #13 is similar to Example #11, except Lanco Flow WPG was used in the formulation instead of BYK-345. Other ingredients were used as shown in Table 4. This formulation was kept for 21 days. The particle size analyzer (using MicroTrac UPA instruments) was used to observe any particle growth in the solution over time. FIG. 2 shows the particle size distribution in the solution after 21 days as series (c). Example #13 has a relatively narrow size distribution from ˜6.4 nm to ˜20 nm.

In certain embodiments, colloidal silica can be stabilized for 21 days without transformation to gel using certain stabilizers, such as Surfynol 104E and Lanco Flow WPG.

In certain embodiments, a relatively narrow particle size distribution (6 to 25 nm) with smaller particle sizes may be obtained using certain stabilizers, such as Surfynol 104E. Furthermore, Surfynol 104E may prevent approximately 30% growth of particles on aging in comparison with BYK-345.

In certain embodiments, a relatively narrow particle size distribution (6 to 20 nm) with smaller particle sizes may be obtained using certain stabilizers, such as Lanco Flow WPG. Furthermore, Lanco Flow WPG may prevent approximately 45% growth of particles on aging in comparison with BYK-345 and may prevent approximately 20% growth of particles on aging in comparison with Surfynol 104E.

In certain embodiments, the particle size distribution has upper and lower limits between 2 and 40 nm, preferably between 4 and 30 nm, and most preferably between 6 and 25 nm.

In certain embodiments, acetone may be partially or completely replaced by or substituted with methyl ethyl ketone, tetrahydrofuran (THF), ethyl acetate, methyl acetate, and/or N,N-dimethylformamide. Similarly, in certain embodiments, n-propanol and n-butanol may be partially or completely replaced by or substituted with other solvents such as ethanol, methoxyethanol, methoxypropanol, 2-ethoxyethanol, 2-methoxyethanol isobutylalcohol, etc.

All numerical ranges and amounts are approximate and include at least some variation.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. A method of making a stabilized colloidal silica solution, the method comprising:
forming a solution by mixing at least colloidal silica, a solvent, and a stabilizing agent, wherein the stabilizing agent is selected from the group consisting of siloxane-based stabilizers, polysorbate-based stabilizers, non-ionic surfactant based stabilizers, and acrylic polymer-based flow-enhancing stabilizers; and
agitating the solution.

2. The method of claim 1, wherein the stabilizing agent comprises less than 10 wt % of the solution.

3. The method of claim 1, wherein the stabilizing agent comprises less than 2 wt % of the solution.

4. The method of claim 1, wherein a particle size of silica in the solution comprising colloidal silica is no more than 100 nm, more preferably no more than 75 nm, and even more preferably no more than 50 nm.

5. A method of making a stabilized colloidal silica solution, comprising:
forming a solution by serially adding the following ingredients: a first solvent; acetone; a stabilizing agent selected from the group consisting of siloxane-based stabilizers, polysorbate-based stabilizers, non-ionic surfactant based stabilizers, and acrylic polymer-based flow-enhancing stabilizers; an intermediate, wherein the intermediate was formed by serially mixing a first silane, a phenone, a triethlyamine, and a second solvent; a second silane; a color stock, wherein the color stock was formed by mixing a third solvent, acetone, a colorant, and a colloidal silica; acetic acid; and water.

6. The method of claim 5, wherein the stabilizing agent comprises less than 10 wt % of the solution.

7. The method of claim 5, wherein the stabilizing agent comprises less than 5 wt % of the solution.

8. The method of claim 5, wherein the stabilizing agent comprises less than 1 wt % of the solution.

9. The method of claim 5, wherein the first silane comprises 3-glycidoxypropyltrimethoxysilane.

10. The method of claim 5, wherein the second silane comprises phenyl triethoxysilane, tetraethoxysilane, or both phenyl triethoxysilane and tetraethoxysilane.

11. The method of claim 5, wherein the first solvent, second solvent, and/or third solvent comprise an alcohol.

12. The method of claim 5, wherein the phenone comprises 2,2,4,4 tetrahydroxybenzophenone.

13. The method of claim 5, wherein a particle size distribution of silica in the solution comprising colloidal silica has a lower limit and an upper limit between 2 and 40 nm, preferably between 4 and 30 nm.

14. A composition comprising a colloidal silica, a solvent, and a stabilizing agent, wherein the stabilizing agent is selected from the group consisting of siloxane-based stabilizers, polysorbate-based stabilizers, non-ionic surfactant based stabilizers, and acrylic polymer-based flow-enhancing stabilizers.

15. The composition of claim 14, wherein the stabilizing agent comprises less than 10 wt % of the solution.

16. The composition of claim 14, wherein the stabilizing agent comprises less than 2 wt % of the solution.

17. The composition of claim 14, wherein a particle size of silica in the composition is no more than 100 nm, more preferably no more than 75 nm, and even more preferably no more than 50 nm.

18. A coated article comprising:
a glass substrate;
a UV-blocking film provided on the glass substrate;
wherein the film comprises a stabilizing agent for stabilizing colloidal silica, wherein the stabilizing agent is selected from the group consisting of siloxane-based stabilizers, polysorbate-based stabilizers, non-ionic surfactant based stabilizers, and acrylic polymer-based flow-enhancing stabilizers.

19. The coated article of claim 18, wherein the coated article is used in a window unit.
